(19) United States
(12) Patent Application Publication
(10) Pub. No.: US 2018/0061449 A1
(43) Pub. Date: Mar. 1, 2018

(54) Binaural Audio-Video Recording Using Short Range Wireless Transmission from Head Worn Devices to Receptor Device System and Method

(71) Applicant: BRAGI GmbH, Munchen (DE)

(72) Inventors: Javier Badajoz Dávila, Munchen (DE); Peter Vincent Boesen, Munchen (DE)

(73) Assignee: BRAGI GmbH, Munchen (DE)

(21) Appl. No.: 15/691,547

(22) Filed: Aug. 30, 2017

Related U.S. Application Data
(60) Provisional application No. 62/381,174, filed on Aug. 30, 2016.

(51) Int. Cl. G11B 20/00; H04R 5/027; H04R 1/10; H04R 3/00; G11B 20/10; G11B 27/28; H04N 5/77; H04N 5/225

(52) U.S. Cl. CPC G11B 20/00992; H04R 5/027; H04R 1/1016; H04R 3/005; H04R 2420/07; G11B 27/28; H04N 5/77; H04N 5/2257; G11B 20/10527

(57) ABSTRACT

A method of recording sound in a binaural manner and transmitting the sound to an electronic device using a wearable device is provided. The method includes receiving audio at a left microphone externally positioned proximate to a left ear opening of a user and at a right microphone externally positioned proximate to a right ear opening of the user, both the left microphone and the right microphone worn on a head of the user. The method further includes acquiring video with a camera worn on the head of the user while receiving the audio. The method further includes collecting the audio and the video at the electronic device and synchronizing the audio with the video at the electronic device to generate an audio-video file. The method further includes storing the audio-video file on a machine readable non-transitory storage medium of the electronic device.

### PRIORITY STATEMENT

This application claims priority to U.S. Provisional Patent Application 62/381,174, filed on Aug. 30, 2016, and entitled “Binaural Audio-Video Recording Using Short Range Wireless Transmission from Head Worn Devices to Receptor Device System and Method”, hereby incorporated by reference in its entirety.

### FIELD OF THE INVENTION

The present invention relates to wearable devices. More particularly, but not exclusively, the present invention relates to stereophonic audio-video (AV) systems and methods.

### BACKGROUND

Current systems for audio video recording present a limited view of the world. This is due to the inability of current state of the art systems available to the user for simultaneous recording of the entire sound sphere encountered when recording video. In the past, expensive systems with two or more microphones used large and bulky systems that limited the effective utility of the technology due to the bulky nature of such accessories. Other attempts to provide stereophonic recording capabilities have been limited due to the positioning and location of the microphones on the device itself. Such microphones residing on the device provide limited spatial sound separation and are subject to shearing effects from the manipulation of the primary device itself. Further, the optimal experience may or may not be represented in such a recording due to the relative position of the microphones relative to the subject matter being captured. What is needed is a new system and method for capture of stereophonic recordings while simultaneously recording video of an event.

### SUMMARY

Therefore, it is a primary object, feature, or advantage of the present invention to improve over the state of the art.

It is a further object, feature, or advantage to provide stereophonic, binaural audio recording capability from the user's standpoint.

It is a still further object, feature, or advantage to provide multiple point audio capture from distinct left and right sides of the user obtaining the audio capture.

Another object, feature, or advantage is the ability to aggregate known microphones worn by the user on the left and right sides of the body in order to spatially segregate the incoming audio.

Yet another object, feature, or advantage is to provide the ability to wirelessly transmit data from a head worn system to a video recording device.

A further object, feature, or advantage is to provide the ability to integrate an audio recording synchronously with a video recording.

A still further object, feature, or advantage is to store a file on the video recording device to allow for synchronous audio/video playback.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an object, feature, or advantage stated herein.

According to one aspect, a system provides for utilization of separately worn devices on the head of the user such as microphones embedded into the lateral aspects of eyepieces, or alternately embedded within left and right earpieces. Said earpieces may be physically linked or completely wireless. These earpieces could also be used in conjunction with eyepieces to more accurately place the sound field three dimensionally for adequate recording. The recording of the sound field may then be assimilated and transmitted wirelessly to a video recording device for precise inclusion into a recorded file. This allows other users to experience an immersive audio-video experience as experienced by the user making the recordings.

According to one aspect, a method of recording sound in a binaural manner and transmitting the sound to an electronic device using a wearable device is provided. The method includes receiving audio at a left microphone externally positioned proximate to a left ear opening of a user and at a right microphone externally positioned proximate to a right ear opening of the user, both the left microphone and the right microphone worn on a head of the user. The method further includes acquiring video with a camera worn on the head of the user while receiving the audio. The method further includes collecting the audio and the video at the electronic device and synchronizing the audio with the video at the electronic device to generate an audio-video file. The method further includes storing the audio-video file on a machine readable non-transitory storage medium of the electronic device.

### BRIEF DESCRIPTION OF THE DRAWINGS

FIG. 1 illustrates a system for audio-video recording.

FIG. 2 is a block diagram of one example of an earpiece.

FIG. 3 is block diagram of one example of a camera device such as a set of smart glasses.

FIG. 4 is a block diagram of one example of a method.

### DETAILED DESCRIPTION

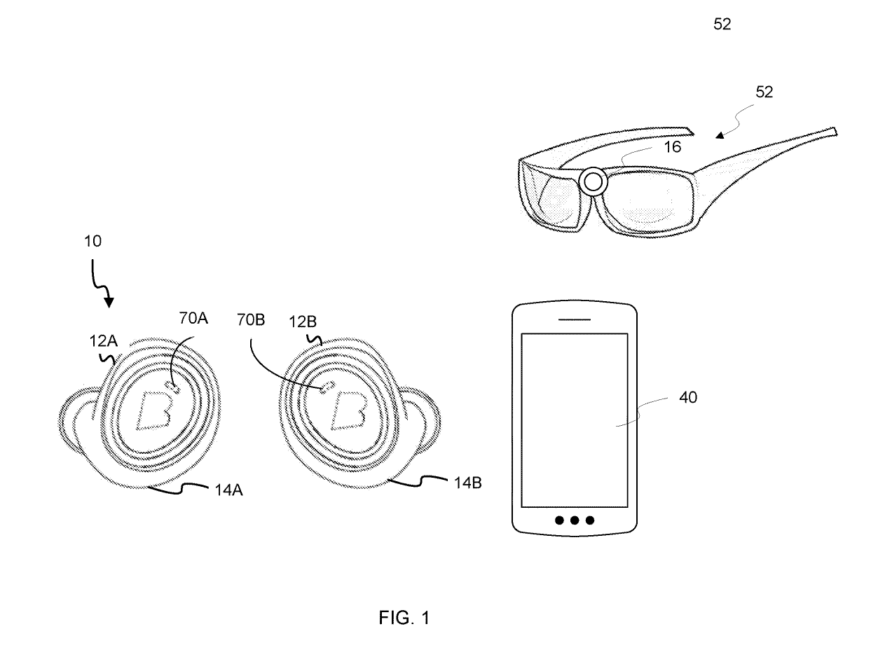

FIG. 1 illustrates one example of a system for performing methods described herein. In FIG. 1, a set of earpieces 10 are shown. Although it is preferred that the earpieces be wireless earpieces, other types of earpieces including headsets, headphones, and other head worn devices are contemplated. A left earpiece 12A has a housing 14A. A laterally facing microphone 70A is shown which may be used to acquire environmental audio. Similarly, a right earpiece 12B has a housing 14B. A laterally facing microphone 70B is shown which may also be used to acquire environmental audio. It is to be understood that placement of the microphones is at or proximate the external auditory canal of a user. Thus, by detecting audio at this location one is acquiring audio the same or similar to what an individual would hear.

FIG. 1 further illustrates a set of eyeglasses 52 of a conventional type with a camera 16 mounted on a frame of the eyeglasses. The camera 52 may be configured to acquire video imagery. In operation, audio from the left earpiece 12A and the right earpiece 12B is acquired at the same time as video imagery is acquired with the camera 16.

Audio and video collected may be encoded in any number of ways. In some applications, time information may be embedded into audio or video files or streams which are collected. The audio and video may be connected to one of the devices shown such as to one earpiece from the other earpiece and from the eyeglasses or alternatively from both earpieces to the eyeglasses. Alternatively, both audio and video may be communicated to another device such as a mobile device 40. The mobile device 40 may then synchronize audio from the earpieces and video from the eyeglasses. This synchronization may be performed in various ways. For example, it may be performed using time codes embedded into the audio and video. In some embodiments where streaming audio and streaming video are received at the same device in real-time, the streams may simply be combined. The result is a combined audio-video stream or file which includes both audio and video from a user's point of view. Moreover, due to placement of microphones at a location at or proximate the external auditory canal of a user, an experience similar to what a user experienced can be re-created.

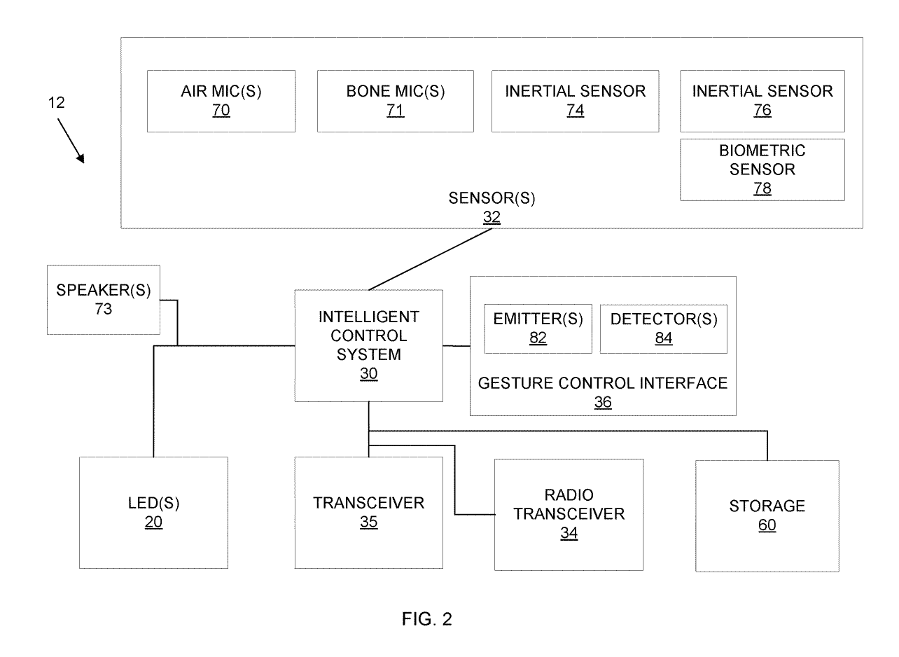

FIG. 2 illustrates a block diagram for an earpiece 12 in additional detail. As shown in FIG. 2, various sensors 32 may be operatively connected to an intelligent control system 30 which may include one or more processors. The sensors 32 may include one or more air microphones 70, one or more bone microphones 71, one or more inertial sensors 74, 76, and one or more biometric sensors 78. A gesture control user interface 36 is shown which is operatively connected to the intelligent control system 30. The gesture control interface 36 may include one or more emitters 82 and one or more detectors 84 that are used for receiving different gestures from a user as user input. Example of such gestures may include taps, double taps, tap and holds, swipes, and other gestures. Of course, other types of user input may be provided including voice input through one or more of the microphones 70, 71 or user input through manual inputs such as buttons. As shown in FIG. 2, one or more LEDs 20 may be operatively connected to the intelligent control system 30 such as to provide visual feedback to a user. In addition, a transceiver 35 may be operatively connected to the intelligent control system 30 and allow for communication between the wireless earpiece 12 and another earpiece. The transceiver 35 may be a near field magnetic induction (NFMI) transceiver or other type of receiver such as, without limitation, a Bluetooth, ultra-wideband (UWB) or other type of wireless transceiver. A radio transceiver 34 may be present which is operatively connected to the intelligent control system 30. The radio transceiver 34 may, for example, be a Bluetooth transceiver, an UWB transceiver, Wi-Fi, frequency modulation (FM), or other type of transceiver to allow for wireless communication between the earpiece 12 and other types of computing devices such as desktop computers, laptop computers, tablets, smart phones, vehicles (including drones), or other devices. The storage 60 is a non-transitory machine readable storage medium which may be operatively connected to the intelligent control system 30 to allow for storage including of audio files, video files, audio-video files, or other information.

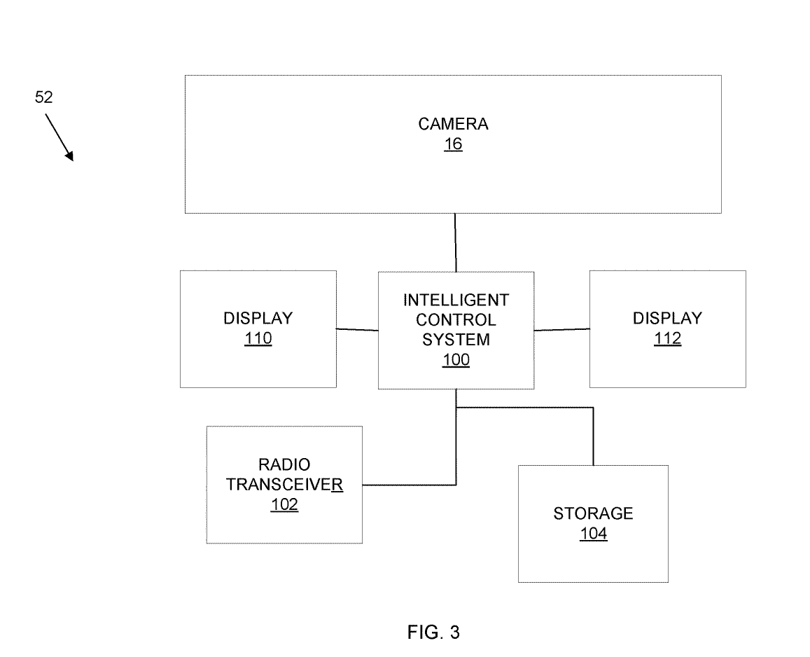

FIG. 3 is a block diagram of one example of a set of eyeglasses 52 in greater detail. A camera 16 is shown. It is to be understood that more than one camera may be present. Each camera 16 is operatively connected to an intelligent controls system 100 which may include one or more processors, digital signal processors, microcontrollers, graphics processors, and associated electronics. A first display 110 such as associated with a first lens and a second display 112 such as associated with a second lens may be operatively connected to the intelligent control systems. A radio transceiver 102 is operatively connected to the intelligent control system 100. The radio transceiver 102 may be a Bluetooth transceiver, Wi-Fi transceiver, or other type of radio transceiver. Storage 104 is also shown which is operatively connected to the intelligent control system 100. The storage 104 may be a non-transitory computer readable memory which may be used to store video, audio, or audio-video files.

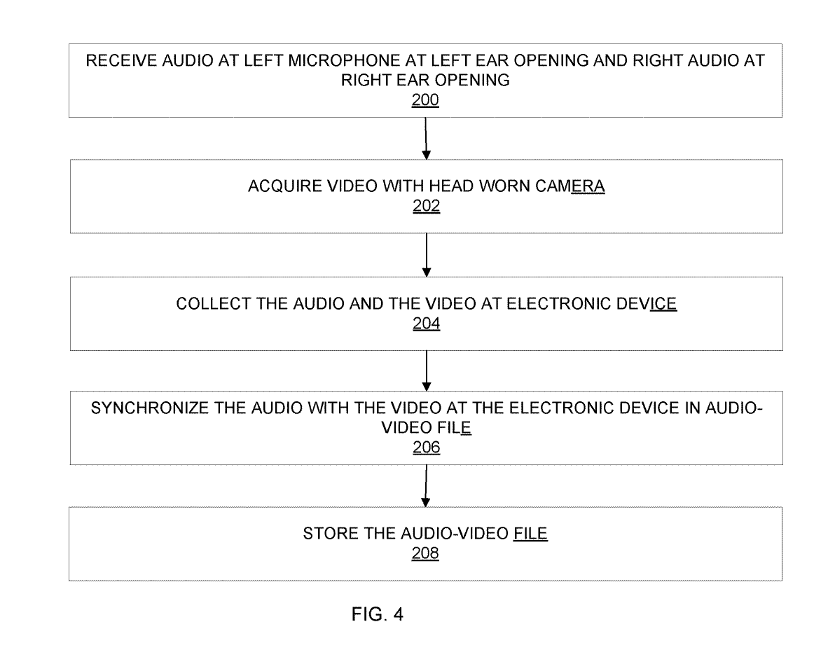

FIG. 4 is a flow diagram illustrating one example of a method of recording sound in a binaural manner and transmitting the sound to an electronic device using a wearable device. In step 200, audio is received at a left microphone externally positioned proximate to a left ear opening of a user and at a right microphone externally positioned proximate to a right ear opening of the user, both the left microphone and the right microphone worn on a head of the user. In step 202, video is acquired with a camera worn on the head of the user while receiving the audio. In step 204, the method provides for collecting the audio and the video at the electronic device. Audio and video may be collected by wirelessly receiving an audio stream and a video stream at the electronic device. Alternatively, audio and video may be collected by receiving one or more audio files and video files at the electronic device. For example, audio from the left earpiece may be stored as a first audio file on the left earpiece. Similarly, audio from the right earpiece may be stored as a second audio file on the right earpiece. Audio from the camera device may be stored as a video file on the camera device. These files may then be transferred to the electronic device for processing. In step 206, the method provides for synchronizing the audio with the video at the electronic device to generate an audio-video file. In step 208, the method provides for storing the audio-video file on a machine readable non-transitory storage medium of the electronic device.

Although various methods and systems have been shown and described it is to be understood that the present invention contemplates numerous options, variations, and alternatives.

What is claimed is:

1. A method of recording sound in a binaural manner and transmitting the sound to an electronic device using a wearable device comprising:
receiving audio at a left microphone externally positioned proximate to a left ear opening of a user and at a right microphone externally positioned proximate to a right ear opening of the user, both the left microphone and the right microphone worn on a head of the user;
acquiring video with a camera worn on the head of the user while receiving the audio;
collecting the audio and the video at the electronic device;
synchronizing the audio with the video at the electronic device to generate an audio-video file; and
storing the audio-video file on a machine readable non-transitory storage medium of the electronic device.

2. The method of claim 1 wherein the left microphone is a laterally directed microphone of a left earpiece and wherein the right microphone is a laterally directed microphone of a right earpiece.

3. The method of claim 2 wherein the camera is integrated into eyeglasses.

4. The method of claim 3 wherein the imaging sensor is integrated into eyeglasses between a left lens and a right lens of the eyeglasses.

5. The method of claim 4 wherein the electronic device is a mobile phone.

6. The method of claim 5 wherein the collecting the audio and the video at the electronic device comprises wirelessly receiving an audio stream from the left earpiece, an audio stream from the right earpiece, and a video stream from the eyeglasses.

7. The method of claim 2 further comprising storing the audio from the left microphone of the left earpiece as a first audio file on the left earpiece.

8. The method of claim 7 further comprising storing the audio from the right microphone of the right earpiece as a second audio file on the right earpiece.

9. The method of claim 8 wherein the collecting the audio and the video at the electronic device comprises receiving the first audio file and the second audio file at the electronic device.
